(19) United States
(12) Patent Application Publication
(10) Pub. No.: US 2026/0147578 A1
(43) Pub. Date: May 28, 2026

(54) REORDERING DISPATCHED INSTRUCTIONS IN GRAPHICS PROCESSING

(71) Applicant: QUALCOMM Incorporated, San Diego, CA (US)

(72) Inventors: Yun DU, San Diego, CA (US); Zilin YING, San Diego, CA (US); Wenfeng HUANG, San Diego, CA (US); Sai Ramesh BHYRAVAJOSULA, San Diego, CA (US); Andrew Evan GRUBER, Arlington, MA (US); Chun YU, Rancho Santa Fe, CA (US); Eric DEMERS, San Diego, CA (US)

(21) Appl. No.: 18/962,724

(22) Filed: Nov. 27, 2024

(51) Int. Cl. G06F 9/38; G06T 15/00

(52) U.S. Cl. CPC G06F 9/3856; G06T 15/005

(57) ABSTRACT

Aspects presented herein relate to methods and devices for graphics processing including an apparatus, e.g., a GPU. The apparatus may obtain a set of instructions associated with the graphics processing. The apparatus may also determine a priority order for each of the set of instructions associated with the graphics processing. Further, the apparatus may identify at least one instruction in the set of instructions based on the priority order for each of the set of instructions. The apparatus may also execute the at least one instruction based on identification of the at least one instruction.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A graphics processor of a device may be configured to perform the processes in a graphics processing pipeline. Further, graphics processors may execute a number of different instructions in a graphics processing pipeline. However, there has developed a need for improved instruction execution in graphics processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a central processing unit (CPU), or any apparatus that may perform for graphics processing. The apparatus may obtain a set of instructions associated with the graphics processing. The apparatus may also determine a priority order for each of the set of instructions associated with the graphics processing. Additionally, the apparatus may generate an instruction queue for the set of instructions based on the priority order for each of the set of instructions. The apparatus may also arrange, in the instruction queue, each of the set of instructions in the priority order for each of the set of instructions. The apparatus may also identify at least one instruction in the set of instructions based on the priority order for each of the set of instructions. Moreover, the apparatus may reserve at least one execution slot for the at least one instruction. The apparatus may also execute the at least one instruction based on identification of the at least one instruction. The apparatus may also output an indication of the execution of the at least one instruction based on the identification of the at least one instruction.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example graphics processing unit (GPU) in accordance with one or more techniques of this disclosure.

FIG. 3 is a diagram illustrating example processing components in accordance with one or more techniques of this disclosure.

FIG. 4 is a diagram illustrating an example GPU hardware in accordance with one or more techniques of this disclosure.

FIG. 5 is a diagram illustrating an example GPU in accordance with one or more techniques of this disclosure.

FIG. 6 is a diagram illustrating an example GPU in accordance with one or more techniques of this disclosure.

FIG. 7 includes diagrams illustrating an example GPU in accordance with one or more techniques of this disclosure.

FIG. 8 is a diagram illustrating an example instruction execution process in accordance with one or more techniques of this disclosure.

FIG. 9 is a diagram illustrating example shader code in accordance with one or more techniques of this disclosure.

FIG. 10 is a diagram illustrating an example instruction execution process in accordance with one or more techniques of this disclosure.

FIG. 11 is a diagram illustrating example shader code in accordance with one or more techniques of this disclosure.

FIG. 12 is a communication flow diagram illustrating example communications between a GPU, a CPU/GPU, and a memory in accordance with one or more techniques of this disclosure.

FIG. 13 is a flowchart of an example method of graphics processing in accordance with one or more techniques of this disclosure.

FIG. 14 is a flowchart of an example method of graphics processing in accordance with one or more techniques of this disclosure.

### DETAILED DESCRIPTION

GPUs may include streaming processors (SPs) or wave schedulers, which includes wave slots (aka Hwave slots) and execution slots (aka Eslots), as well as a wave slot queue, and execution slot queue hierarchy, an instruction scheduling arbiter, and execution units (e.g., a decoder). Wave slot context registers may store information, such as instruction program counter (PC), fiber coverage mask, shader type, etc., which is associated with input data. Once a wave slot is ready to execute an instruction, a wave scheduler may copy the wave slot context registers to an execution slot. After this, the wave scheduler may start to dispatch instructions to corresponding execution units, track an instruction execution, synchronize data dependency, switch out stalled waves (i.e., waves that are waiting for data to return from external memory) from an execution slot to a wave slot queue. The wave scheduler may also switch in ready wave slots to an execution slot. As indicated herein, because execution slots issue instruction one-by-one, if all execution slots are waiting to issue the same type of instructions, this may block subsequent non-dependent instructions to other execution units for many cycles, and thus impairs execution slot efficiency. In order to combat this issue, the wave scheduler may add buffer between an execution slot queue and execution units, but this creates another performance problem as the buffer may allow other waves to issue instructions and increase the chance of interleaving instructions from different waves, which may result in the synchronization overhead increasing. That is, when the execution slots are issuing instructions one-by-one, the program counters (PCs) may need to wait for each program counter that is in front of it, even if they are different types of instructions. As such, this creates a backup of instructions. Also, other types of solutions (e.g., adding a buffer) may cause the instructions to be issued out of order. Aspects of the present disclosure reduce a backlog for shader instructions at a GPU. Aspects of the present disclosure may also ensure that instructions are issued in a correct order at a GPU.

Aspects of the present disclosure may include a number of benefits or advantages. For instance, aspects of the present disclosure may help to alleviate a data or instruction backlog. For example, aspects presented herein may reduce a backlog for data or instructions (e.g., shader instructions) at a GPU. Aspects presented herein may also ensure that data or instructions are issued in a correct order. For instance, aspects of the present disclosure may verify that data or instructions (e.g., shader instructions) are issued in a correct order at a GPU. That is, aspects presented herein may arrange a set of instructions or data in a priority order. For example, aspects presented herein may arrange instructions or data based on a wave priority for the instructions. Also, aspects presented herein may select at least one instruction for execution that includes a highest priority in the priority order. By doing so, aspects presented herein may allow lower priority waves to issue certain instructions (e.g., slow instructions) and free up subsequent independent instructions. This may alleviate a burden on a compiler to generate back-to-back instructions. Further, aspects presented herein may improve parallel execution and execution slot utilization at GPUs. Also, aspects presented herein may allow an SP scheduler to restore back-to-back elementary function unit (EFU)/texture/load execution through reordering an instruction queue, even though a compiler does not place these instructions back-to-back. Also, aspects presented herein may enable lower priority waves to issue slow instructions to an instruction queue and free up subsequent independent instructions early, in order to improve parallel execution and Eslot utilization.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

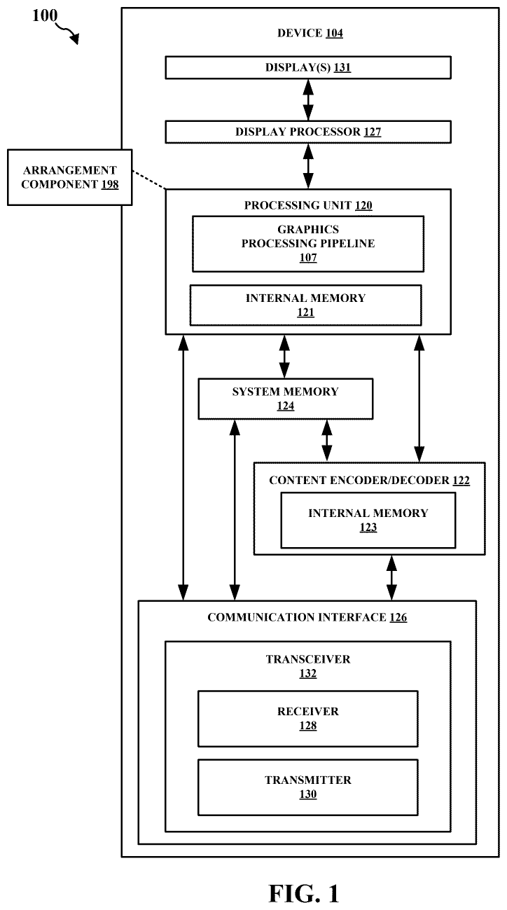

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include an arrangement component 198 configured to obtain a set of instructions associated with the graphics processing. The arrangement component 198 may also be configured to determine a priority order for each of the set of instructions associated with the graphics processing. The arrangement component 198 may also be configured to generate an instruction queue for the set of instructions based on the priority order for each of the set of instructions. The arrangement component 198 may also be configured to arrange, in the instruction queue, each of the set of instructions in the priority order for each of the set of instructions. The arrangement component 198 may also be configured to identify at least one instruction in the set of instructions based on the priority order for each of the set of instructions. The arrangement component 198 may also be configured to reserve at least one execution slot for the at least one instruction. The arrangement component 198 may also be configured to execute the at least one instruction based on identification of the at least one instruction. The arrangement component 198 may also be configured to output an indication of the execution of the at least one instruction based on the identification of the at least one instruction. Although the following description may be focused on graphics processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

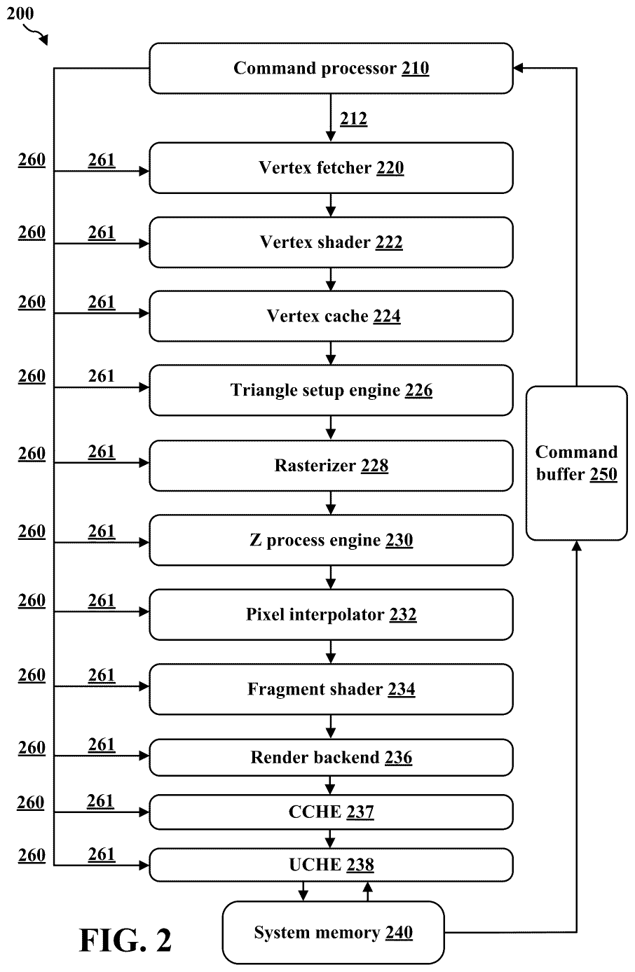

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

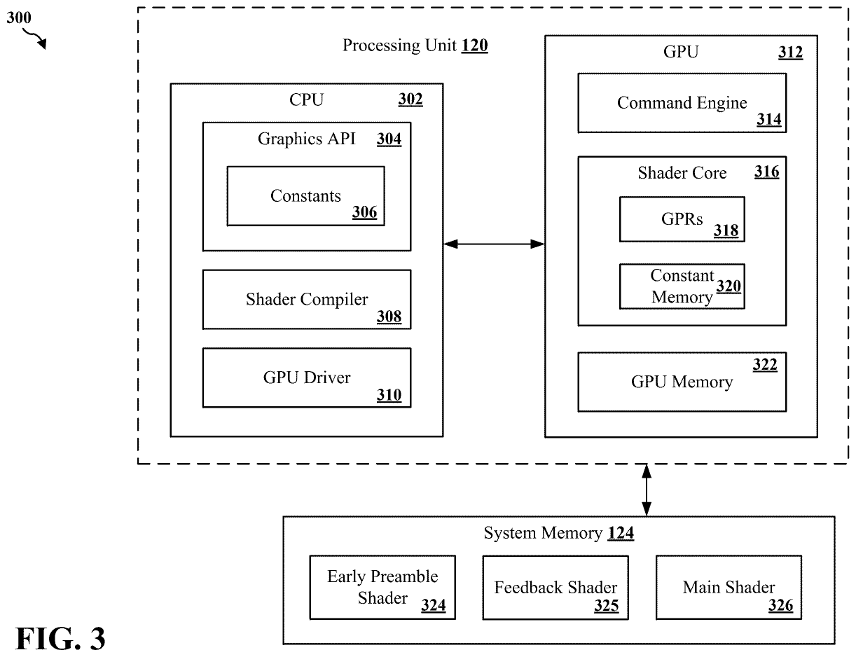

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

In some aspects, different types of GPU hardware may support different types of workload execution. For instance, GPU hardware may support concurrent execution of different workloads. Concurrent execution may refer to the simultaneous execution of workloads at a GPU. Also, concurrent execution may refer to the execution of workloads in parallel at a GPU. GPU hardware may also support concurrent execution of different workloads in a time-shared manner. In some instances, concurrent execution of different workloads in a time-shared manner may improve the performance per area at the GPU. However, in other instances, concurrent execution of different workloads in a time-shared manner may reduce the performance per area at the GPU. Additionally, different types of workloads may take a different amount of processing time in various stages of the GPU pipeline. Also, these types of workloads may introduce inefficiency in GPU hardware utilization.

In some aspects, scheduling algorithms in order to time-share the GPU hardware may sequence the workload to achieve the best utilization of GPU hardware. However, some types of workloads may block the execution of other successive workloads. For instance, some workloads with a higher specification for a resource (e.g., memory access latency) may block the execution of other successive workloads, which may have reduced resource specification and a faster execution time (e.g., head of line blocking). In turn, this may reduce the overall hardware efficiency at the GPU. This kind of workload pattern is common in certain types of binning (e.g., concurrent binning). For example, in concurrent binning, a tile sorting pass for a certain frame (e.g., frame ‘N+1’) may be run concurrently with a rendering pass of another frame (e.g., frame ‘N’).

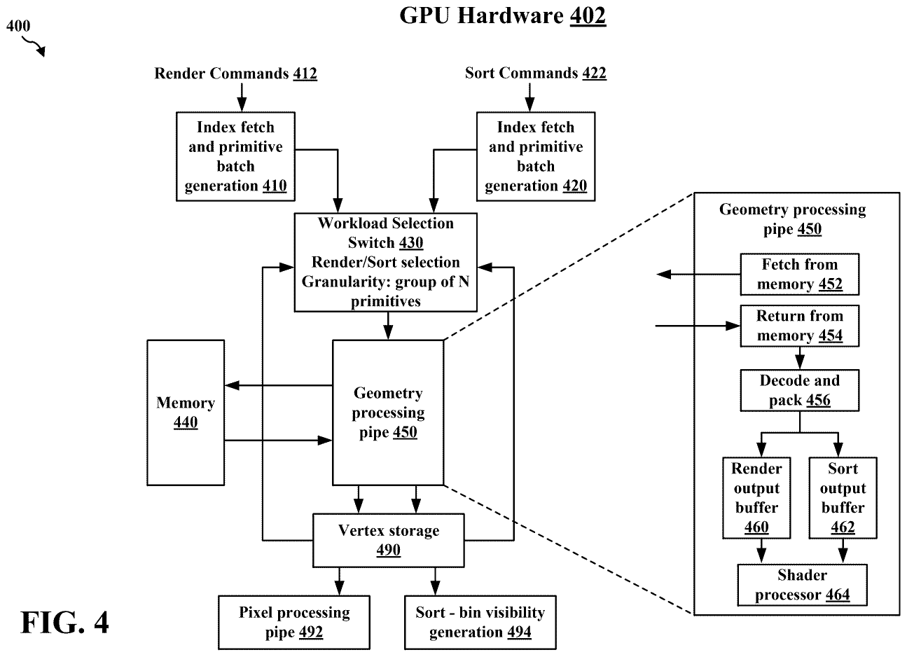

FIG. 4 illustrates diagram 400 including one example of GPU hardware. More specifically, diagram 400 depicts a time-shared GPU hardware for concurrent binning. As shown in FIG. 4, diagram 400 includes GPU hardware 402 including index fetch and primitive batch generation component 410, index fetch and primitive batch generation component 420, software 430, memory 440, geometry processing pipe 450, vertex storage component 490, pixel processing pipe 492, and sort-bin visibility generation component 494. As shown in FIG. 4, render commands 412 may be input to index fetch and primitive batch generation component 410, which may be output to software 430. Similarly, sort commands 422 may be input to index fetch and primitive batch generation component 420, which may be output to software 430. The software 430 may have a render/sort selection capability, as well as a certain granularity (e.g., a granularity for a group of N primitives). The output of software 430 may be sent to geometry processing pipe 450, which may communicate with memory 440. The geometry processing pipe 450 may include fetch from memory component 452, return from memory component 454, decode and pack component 456, render output buffer 460, sort output buffer 462, and shader processor 464. Also, the output of geometry processing pipe 450 may be sent to vertex storage component 490, which may be sent to pixel processing pipe 492 and sort-bin visibility generation component 494.

As shown in FIG. 4, geometry pipe hardware (e.g., geometry processing pipe 450) may be time shared between tile sorting and tile render workloads. Also, a scheduling algorithm (e.g., software 430) may consider the availability of GPU hardware for tile sorting and tile render workload. The granularity of a workload may be selected such that there is limited workload switching overhead. Further, the granularity of a workload may be selected such that, at the same time, one workload does not block the other. As shown in FIG. 4, the software 430 may have a granularity of a group of N primitives. For instance, for concurrent binning, the workload distribution granularity may be a primitive batch (e.g., a set of N primitives).

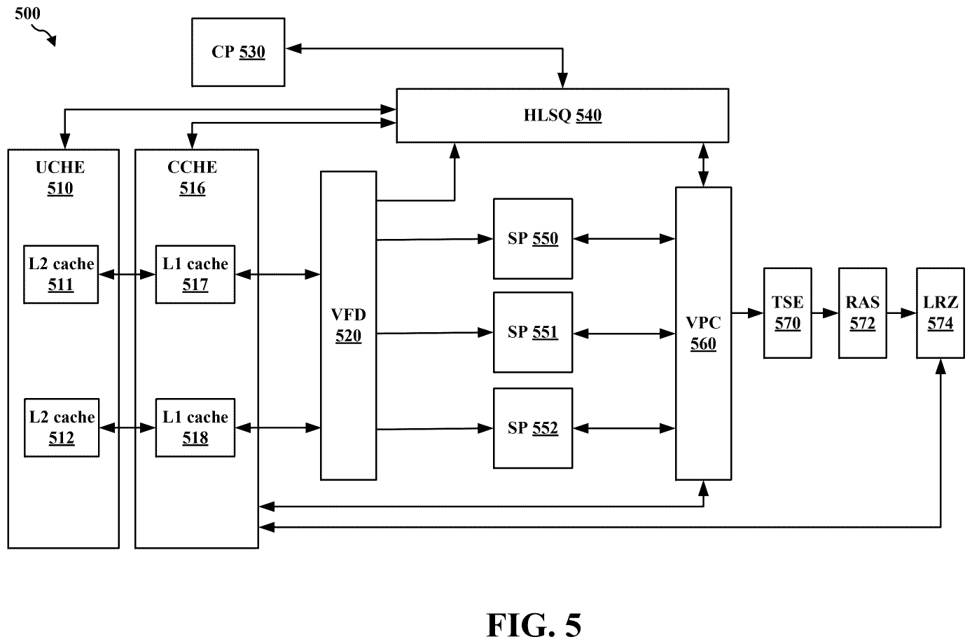

FIG. 5 is a diagram illustrating another example GPU. More specifically, FIG. 5 depicts GPU 500 including a number of different components. As shown in FIG. 5, GPU 500 includes UCHE 510 including L2 cache 511 and L2 cache 512, CCHE 516 including L1 cache 517 and L1 cache 518, VFD 520, CP 530, HLSQ 540, a number of shader processors (e.g., shader processor 550, shader processor 551, and shader processor 552), VPC 560, TSE 570, RAS 572, and low resolution Z (LRZ) component (e.g., LRZ 574). As shown in FIG. 5, CP 530 may transmit data to HLSQ 540 and receive data from HLSQ 540. CCHE 516 may transmit/receive data to/from HLSQ 540. UCHE 510 may also transmit/receive data to/from HLSQ 540. L2 cache 511 and L2 cache 512 may transmit/receive data to/from VFD 520. Further, VFD 520 may transmit data to HLSQ 540, as well as transmit data to shader processors 550-552. Moreover, shader processors 550-552 may transmit/receive data to/from VPC 560. Also, VPC 560 may transmit/receive data to/from HLSQ 540. Data can also be transmitted from VPC 560 to TSE 570, which can transmit data to RAS 572, and then to LRZ 574. CCHE 516 can transmit/receive data to/from VPC 560 and LRZ 574. Also, UCHE 510 can transmit/receive data to/from VPC 560 and LRZ 574.

As indicated herein, graphics processors (e.g., GPUs) may work in a number of different fashions (e.g., a single instruction, multiple data (SIMD) fashion). GPUs may process certain types of instructions that are associated with an operation (e.g., an SIMD operation). For instance, a GPU may process wave instructions or waves, which are the width of data elements that are operated on by a single instruction associated with the SIMD. The term wave may also refer to a set of threads or blocks that run concurrently on the GPU. Waves may be allocated into sub-waves, which may include a number of threads or fibers. An active thread/fiber may refer to a thread/fiber that executes instructions (e.g., instructions in the ALU). An inactive thread/fiber may refer to a thread/fiber that does not execute instructions. Threads/fibers that do not partake in a branching operation may eventually become inactive (i.e., partake in the next level of the hierarchy). A kernel may be a programming operations manager or a programming thread at a GPU. Also, a kernel may be executed in parallel by an array of threads/fibers, where all threads/fibers may run the same code. Each thread/fiber may have an identifier (ID) that it uses to compute memory addresses and make control decisions. GPUs may also process a number of different operations, such as an atomic operation. An atomic operation may enable another operation (e.g., a read-modify-write operation or a read-write operation) to occur without any interruption. As such, an atomic operation may assure that no other execution operation at a GPU may have been inserted between the target operation (e.g., a read-modify-write operation or a read-write operation).

In some aspects, a shader in the context of a graphics processor (e.g., a GPU) may be a program that is used to control the rendering effects of 3D computer graphics. There are different types of shaders (e.g., vertex shaders, pixel shaders, and geometry shaders), each of which may handle a different aspect of the rendering process. Shaders may be used to produce realistic lighting, shadows, textures, and other visual effects in video games, simulations, and other 3D applications. A shader processor may utilize one or more context states to perform various operations and calculations. For instance, a shader processor may be part of multiple shared cores for integer processing. Also, a shader processor may execute shader code (e.g., vertex shaders, fragment shaders, compute shaders, etc.). The shader processor may also be referred to as a shader core. Shader code may also be referred to as a shader and may refer to a user-defined program configured to run in a stage of the GPU. In an example, the shader code may be associated with the rendering of graphical content. The shader processor may include a number of different components, such as arithmetic logic units (ALUs) and general purpose registers (GPRs). An ALU may be a combinatorial digital circuit that performs arithmetic and bitwise operations on integer binary numbers (e.g., a signed integer, an unsigned integer, etc.). A GPR may be a register that stores both data and addresses, that is, the GPR may be a combined data/address register. A register may refer to a location that may be accessed by a processor. A register may include a small amount of relatively quickly accessible storage.

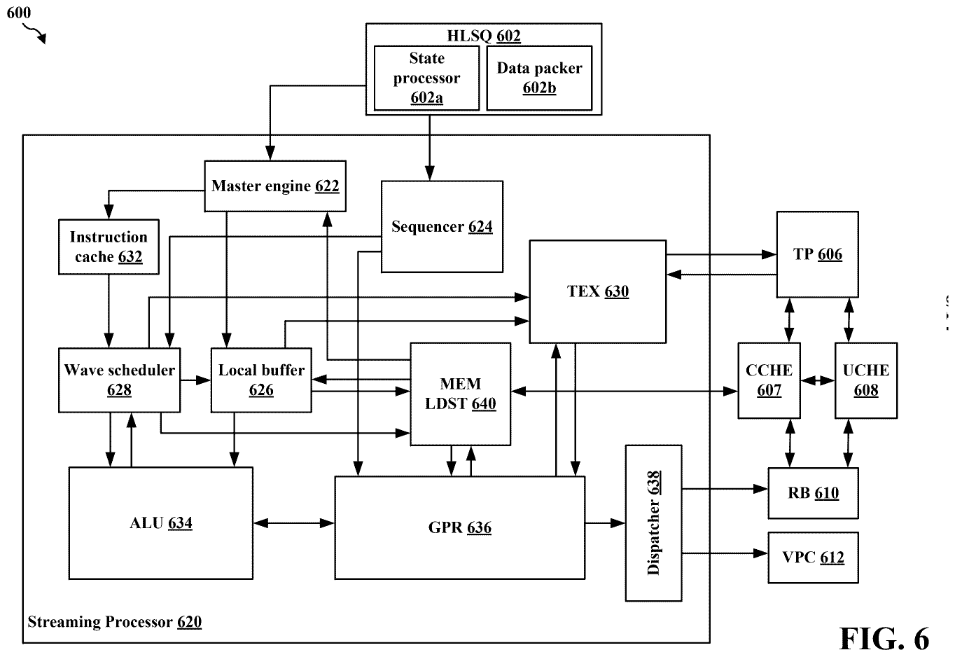

FIG. 6 illustrates an example GPU 600. Specifically, FIG. 6 illustrates a streaming processor or shader processor system in GPU 600. As shown in FIG. 6, GPU 600 includes a high level sequencer (HLSQ) 602, texture processor (TP) 606, level 1 (L1) cache (cluster cache (CCHE)) 607, level 2 (L2) cache (UCHE) 608, render backend (RB) 610, and vertex cache (VPC) 612. GPU 600 also includes streaming processor (SP) 620, master engine 622, sequencer 624, local buffer 626, wave scheduler 628, texture (TEX) 630, instruction cache 632, arithmetic logic unit (ALU) 634, GPR 636, dispatcher 638, and memory (MEM) load store (LDST) 640. In some aspects, streaming processor (SP) 620 may be referred to as a shader processor.

As shown in FIG. 6, each unit or block in GPU 600 may send data or information to other blocks. For instance, HLSQ 602 may send commands to the master engine 622. Also, HLSQ 602 may send vertex threads, vertex attributes, pixel threads, pixel attributes, and/or compute commands to the sequencer 624. TP 606 may receive texture requests from TEX 630, and send texture elements (texels) back to the TEX 630. Further, TP 606 may send memory read requests to and receive memory data from CCHE 607 or UCHE 608. CCHE 607 or UCHE 608 may also receive memory read or write requests from MEM LDST 640 and send memory data back to MEM LDST 640, as well as receive memory read or write requests from RB 610 and send memory data back to RB 610. Also, RB 610 may receive an output in the form of color from GPR 636, e.g., via dispatcher 638. VPC 612 may also receive output in the form of vertices from GPR 636, e.g., via dispatcher 638. GPR 636 may send address data or receive write back data from MEM LDST 640. GPR 636 may also send temporary data to and receive temporary data from ALU 634. Moreover, ALU 634 may send address or predicate information to the wave scheduler 628, as well as receive instructions from wave scheduler 628. Local buffer 626 may send constant data to ALU 634. TEX 630 may also receive texture attributes from or send texture data to GPR 636, as well as receive constant data from local buffer 626. Further, TEX 630 may receive texture requests from wave scheduler 628, as well as receive constant data from local buffer 626. MEM LDST 640 may send/receive constant data to/from local buffer 626. Sequencer 624 may send wave data to wave scheduler 628, as well as send data to GPR 636. The sequencer 624 may allocate resources and local memory. Also, the sequencer 624 may allocate wave slots and any associated GPR 636 space. For example, the sequencer 624 may allocate wave slots or GPR 636 space when the HLSQ 602 issues a pixel tile workload to the SP 620. Master engine 622 may send program data to instruction cache 632, as well as send constant data to local buffer 626 and receive instructions from MEM LDST 640. Instruction cache 632 may send instructions or decode information to wave scheduler 628. Wave scheduler 628 may send read requests to local buffer 626, as well as send memory requests to MEM LDST 640.

As further shown in FIG. 6, the HLSQ 602 may prepare one or more context states for the SP 620. For example, the HLSQ 602 may prepare the context states for different types of data, e.g., global register data, shader constant data, buffer descriptors, instructions, etc. Additionally, the HLSQ 602 may embed context states into a command stream to the SP 620. The master engine 622 may parse the command stream from the HLSQ 602 and setup an SP global state. Moreover, the master engine 622 may fill or add to an instruction cache 632 and/or a local buffer 626 or a constant buffer. In some aspects, inside the HLSQ 602, there may be an internal function unit called a state processor 602a. The state processor 602a may be a single fiber scalar processor that may execute a special shader program, e.g., a preamble shader. The preamble shader may be generated by the GPU compiler in order to load constant data from different buffer objects. Also, the preamble shader may bind the buffer objects into a single constant buffer, such as a post-process constant buffer. Further, the HLSQ 602 may execute the preamble shader and, as a result, skip utilizing a main shader. In some instances, the main shader may perform different shading tasks, such as normal vertex shading and/or a fragment shading program. Moreover, the HLSQ 602 may include a data packer 602b.

Additionally, as shown in FIG. 6, the SP 620 may not be limited to executing a preamble if the HLSQ 602 decides to skip a preamble execution. For instance, the SP 620 may also process a conventional graphics workload, such as vertex shading and/or fragment shading. In some aspects, the SP 620 may utilize its execution units and storage in order to process compute tasks as a general purpose GPU (GPGPU). Inside the SP 620, there may be multiple parallel instruction execution units such as an ALU, elementary function unit (EFU), branching unit, TEX, general memory read and write (aka LDST), etc. The SP 620 may also include on-chip storage memory, such as a GPR 636 which may store per-fiber private data. Also, the SP 620 may include a local buffer 626 which stores per-shader or per-kernel constant data, per-wave uniform data (aka uGPR), and per-compute work group (WG) local memory (LM). Processing a preamble shader may take up one wave slot. Further, the majority of preamble shaders may use just the uGPR and not the GPR, and may execute ALU instructions on a scalar ALU. Therefore, execution of the preamble shader may be associated with high performance, and may be power efficient because any available wave slot may be used to execute the preamble shader even without GPR space allocation.

Moreover, as shown in FIG. 6, dispatcher 638 may fetch data from GPR 636. Dispatcher 638 may also perform format conversion, and then dispatch a final color to multiple render targets (RTs). Each RT may have one or more components, such as red (r) green (G) blue (B) alpha (A) (RGBA) data, or just an alpha component of the RGBA data. Further, each RT may be generally stored in a vector GPR, i.e., R3.0 may store red data, R3.1 may store green data, R3.2 may store blue data, etc. Also, a driver program in an SP context register may be utilized to define the GPR identifier (ID) which stores RT data.

As indicated herein, a kernel may be a programming operations manager or a programming thread at a GPU. Also, a kernel may be executed in parallel by an array of threads, where all threads may run the same code. Each thread may have an identifier (ID) that it uses to compute memory addresses and make control decisions. A warp may be a collection of threads (e.g., 32 threads) that are executed simultaneously by a symmetric multiprocessor (SM). A warp may be a basic unit of execution, where multiple warps may be executed on an SM at once. When a program on a CPU invokes a kernel grid, the blocks of the grid may be enumerated and distributed to SMs with available execution capacity. The threads of a thread block may execute concurrently on one SM, and multiple thread blocks may execute concurrently on one SM. As thread blocks terminate, new blocks are launched on the vacated SMs. The mapping between warps and thread blocks may affect the performance of the kernel. Also, a clock or GPU clock may be a logical beat or time that is used to synchronize actions of the GPU. A clock source may manage how a GPU component derives its clock.

A symmetric multiprocessor (SM) may be single instruction multiple thread processor which has multiple shared cores at a GPU (e.g., shader processors) for integer processing, special functional units (SFUs) (e.g., for calculating functions such as sine, cosine, root mean-squared (RMS), etc.). The SM may have load store (LD/ST) units for load and store into memory/registers. The SM may also have L1 caches, shared caches and large-banked register files. A concurrent thread array (CTA) may be a basic workload unit assigned to an SM in a GPU. Threads in a CTA may be sub-grouped into a warp/wavefronts, which is the smallest execution unit sharing the same program counter. A last level cache (LLC) may be a last level of cache from a GPUs context, such as an extended cache for SMs. An interconnect unit may be a crossbar switch which does multi-master arbitration, by which GPUs are connected to rest of the world. Further, a pointer of serialization/pointer of coherence (PoS/PoC) may be point in the system-on-chip (SoC) post where every master in the system may see the same coherent copy of data.

Some aspects of graphics processing may utilize certain GPU architectures and/or application structures. For instance, aspects of graphics processing may utilize a general purpose GPU (GPGPU) architecture that includes symmetric multiprocessor (SMs), shared cores, an interconnect unit, a dynamic random access memory (DRAM), and/or a number of different caches (e.g., a first level (L1) cache, a second level (L2) cache, and/or a last level cache (LLC)). In some instances of GPU architectures, a number of SMs, shared cores, and L1 caches may be connected to an interconnect unit. The interconnect unit may be connected to L2 caches and DRAMs. Additionally, in an application structure, an application may include a number of kernels, and each of the kernels may include concurrent thread arrays (CTAs), where each CTA includes a number of warps.

In aspects of graphics rendering, some graphics applications may render to a single target, i.e., a render target, one or more times. For instance, in graphics rendering, a frame buffer on a system memory may be updated multiple times. The frame buffer may be a portion of memory or random access memory (RAM) (e.g., containing a bitmap or storage) to help store display data for a GPU. The frame buffer may also be a memory buffer containing a complete frame of data. Additionally, the frame buffer may be a logic buffer. In some aspects, updating the frame buffer may be performed in bin or tile rendering, where, as discussed above, a surface is divided into multiple bins or tiles and then each bin or tile may be separately rendered. Further, in tiled rendering, the frame buffer may be partitioned into multiple bins or tiles.

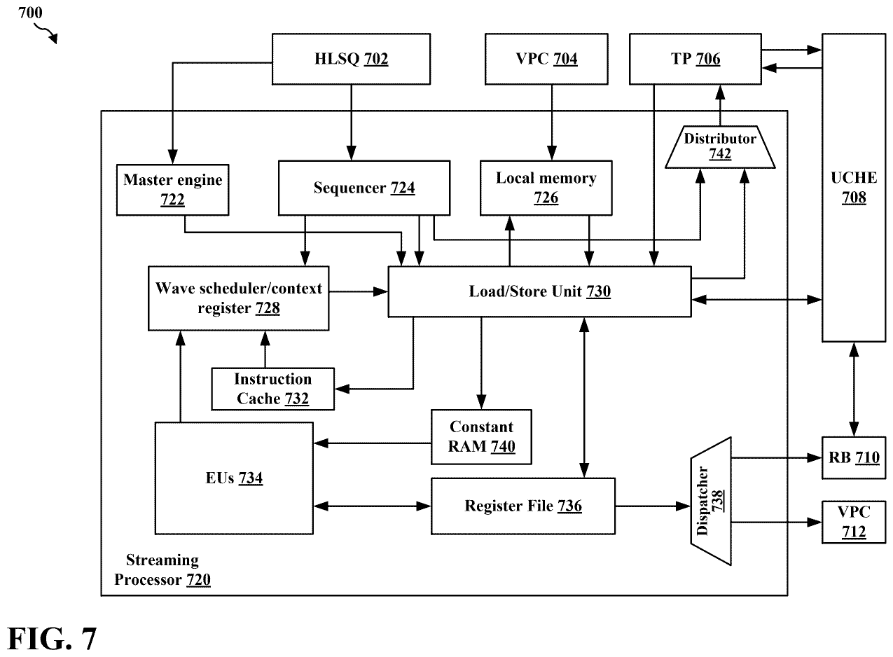

FIG. 7 illustrates an example GPU 700. More specifically, FIG. 7 illustrates a streaming processor (SP) system in GPU 700. As shown in FIG. 7, GPU 700 includes high level sequencer (HLSQ) 702, VPC 704, texture processor (TP) 706, UCHE 708 (e.g., an L2 configurable cache), RB 710, VPC 712, and SP 720. SP 720 includes master engine 722, sequencer 724, local memory 726, wave scheduler/context register 728, load/store unit 730 (e.g., texture (TEX) or load controller), instruction cache 732, execution units (EUs) 734, register file 736 (e.g., a general purpose register (GPR)), dispatcher 738 (e.g., texture distributor), constant RAM 740, and output distributor 742. The wave scheduler/context register 728 may include one or more wave slots. In some aspects, streaming processor (SP) 720 may be referred to as a shader processor.

As shown in FIG. 7, the SP 720 may include traditional function units or blocks (e.g., EUs 734 or sequencer 724). EUs 734 may execute or process some of the desired functions of the GPU. The sequencer 724 may allocate resources and local memory. Also, the sequencer 724 may allocate wave slots and any associated register file 736 space. For example, the sequencer 724 may allocate wave slots or register file 736 space when the HLSQ 702 issues a pixel tile workload to the SP 720. In some aspects, the wave scheduler/context register 728 may execute a pixel shader or issue instructions to the EUs 734. The EUs 734 may also include an arithmetic logic unit (ALU) and/or an elementary function unit (EFU). Further, the load/store unit 730 may be considered an execution unit. Moreover, the load/store unit 730 may correspond to one or multiple units. For instance, the load/store unit 730 may perform a texture fetch and/or the load/store unit 730 may perform a memory fetch. In some aspects, the instruction cache 732 may store a program to be executed. Also, the constant RAM 740 may store the constant that may be needed for a constant or uniform formation. As further shown in FIG. 7, the SP 720 may interface with the outside blocks, e.g., HLSQ 702, VPC 704, TP 706, UCHE 708, RB 710, and VPC 712. These blocks 702-712 may utilize user provided input and/or the SP may output results to these blocks or memory access.

As shown in FIG. 7, each unit or block in GPU 700 may send data or information to other blocks. For instance, HLSQ 702 may send programming/commands to the master engine 722. Also, HLSQ 702 may send vertex threads, vertex attributes, pixel threads, and/or pixel attributes to the sequencer 724. Master engine 722 may send an instruction, constant request to load/store unit 730. VPC 704 may send certain coefficients to local memory 726. TP 706 may send texture data to the load/store unit 730. TP 706 may also receive texture requests from load/store unit 730, e.g., via output distributor 742, and bypass requests from sequencer 724. Further, TP 706 may send requests to and receive texture elements (texels) from UCHE 708. UCHE 708 may also send memory data to and receive memory requests from load/store unit 730, as well as send memory data to and receive memory requests from RB 710. Also, RB 710 may receive an output in the form of color from register file, e.g., via dispatcher 738. VPC 712 may also receive output in the form of vertices from register file 736, e.g., via dispatcher 738. Register file 736 may also send temporary data to and receive temporary data from EUs 734. Moreover, EUs 734 may send address or predicate information to the wave scheduler/context register 728, as well as receive constant data from constant RAM 740. Load/store unit 730 may also send/receive load or store data to/from register file 736, as well as send store data to, and receive load data from, local memory 726. Further, load/store unit 730 may send global data to constant RAM 740 and update information to the instruction cache 732. Load/store unit 730 may also receive attribute data from sequencer 724 and synchronization information from wave scheduler/context register 728. Additionally, wave scheduler/context register 728 may receive decode information from instruction cache 732 and thread data from sequencer 724.

As mentioned above, the GPU 700 may process workloads (e.g., a pixel or vertex workload). In some aspects, these workloads may correspond to, or be referred to as, waves or wave formations. For instance, each workload or operation may use a group of vertices or pixels as a wave. For example, each wave may include 64 vertices or 64 pixels. In some instances, GPU 700 may send a wave formation, e.g., a pixel or vertex workload, to the wave scheduler/context register 728 for execution. For a vertex workload, the GPU may perform a vertex transformation. For a pixel workload, the GPU may perform a pixel shading or lighting.

In some aspects, each of the aforementioned processes or workloads (e.g., the processes or workloads in the SP 720) may include a wave formation. For example, a vertex workload may include a number of vertices, e.g., three vertices. SP 720 may then perform a transformation of these vertices, such that the vertices may transform into a wave. In order to perform this transformation, GPUs may utilize a number of a wave slots (e.g., to help transform the vertices into a wave). Further, in order to execute a workload or program, the GPU may also allocate the GPR space, e.g., including a temporary register to store any temporary data. Additionally, the sequencer 724 may allocate the register file 736 space and one or more wave slots in order to execute a wave. For example, the register file 736 space and one or more wave slots may be allocated when a pixel or vertex workload is issued. In some aspects, the wave scheduler/context register 728 may process a pixel workload and/or issue instructions to various execution units (e.g., EUs 734). The wave scheduler/context register 728 may also help to ensure data dependency between instructions, e.g., data dependency between ALU operands due to the pipeline latency and/or texture sample return data dependency based on a synchronization mechanism.

As shown in FIG. 7 above, GPUs may utilize a streaming processor (SP) 720 (e.g., a sequencer 724 in SP 720) to allocate different workloads to different wave slots. For instance, sequencer 724 may allocate wave slots and associated general purpose register (GPR) space for workloads (e.g., a high level sequencer (HLSQ) issue pixel tile workload (i/j barycentric coefficient data)) to SP 720. Next, a wave scheduler/context register 728 may execute a pixel shader and issue instructions to execution units (EUs) 734 (e.g., arithmetic logic unit (ALU), elementary function unit (EFU), texture (TEX) or load controller (LOAD)). After the shader processing is complete, the SP 720 may dispatch the processed result (i.e., mostly color) to a downstream block (e.g., a render backend (RB) 710). In some aspects, the output order of this process may be the same as the input order, which may be a functional specification. The SP 720 may work efficiently because wave slots that accept and execute a workload earlier may generally finish processing the workload earlier.

In some aspects, as shown in FIG. 7, high level sequencer (HLSQ) 702 may dispatch context states such as global register, shader constant, buffer descriptor, instruction, etc. The HLSQ 702 may also embed context states into a command stream to the master engine 722 (e.g., an SP master engine). In turn, the master engine 722 (e.g., an SP master engine) may parse the command stream from HLSQ 702 and set up an SP global state. The sequencer 724 (aka SEQ) may then allocate wave slots and associated GPR space when the HLSQ 702 dispatches workloads (e.g., vertex or pixel tile workloads) to the SP. Then the wave scheduler/context register 728 may execute vertex or pixel shader workloads and issue instructions to execution units (EUs) 734, such as ALU, EFU, TEX/LOAD, etc. After the shader processing is complete, the SP 720 may dispatch the result to a downstream block (e.g., render backend (RB) 710).

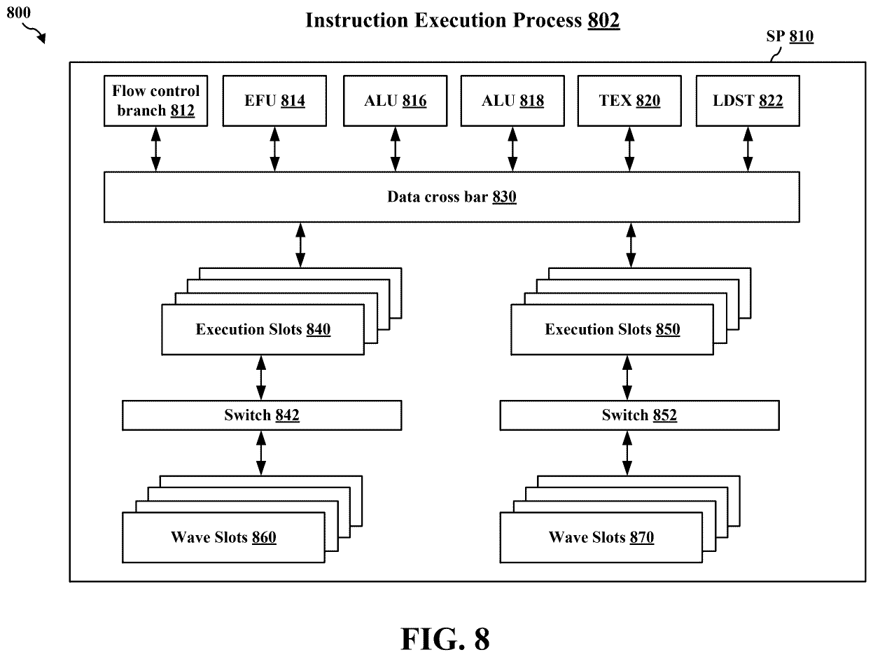

FIG. 8 illustrates diagram 800 including an example instruction execution process. More specifically, diagram 800 depicts one example of an instruction execution process 802 within SP 810 at a GPU. As shown in FIG. 8, diagram 800 includes a number of execution units (e.g., flow control branch 812, EFU 814, ALU 816, ALU 818, TEX 820, and load store (LDST) 822). SP 810 may include a number of additional execution units, as execution units 812-822 are merely an example and any combination or order of execution units can be used by GPUs herein. SP 810 may also include data cross bar 830, which can also be referred to as multiple thread manager and/or a level zero (L0) cache. SP 810 also includes execution slots 840, switch 842 (e.g., a 16-to-4 switch), execution slots 850, and switch 852 (e.g., a 16-to-4 switch). Further, SP 810 includes a number of wave slots (e.g., wave slots 860 and wave slots 870). SP 810 may include any number of different wave slots, as wave slots 860 and wave slots 870 are merely an example. In some aspects, wave slots 860 and wave slots 870 may be part of a wave scheduler.

As shown in FIG. 8, each component in SP 810 may communicate with a number of other components. For instance, each of the execution units (e.g., flow control branch 812, EFU 814, ALU 816, ALU 818, TEX 820, and LDST 822) may send or receive data or instructions (e.g., requests or grants) to/from the data cross bar 830. Also, each of the wave slots 860 and wave slots 870 can send or receive data or instructions (e.g., requests or grants) to/from the data cross bar 830. Further, data cross bar 830 may store data in, or receive data from, an LO cache. Each of the execution units (e.g., flow control branch 812, EFU 814, ALU 816, ALU 818, TEX 820, and LDST 822) may also send or receive data or instructions to/from the wave slots 860 and wave slots 870. In some aspects, each of the wave slots 860 and wave slots 870 may issue instructions simultaneously to each of the execution units (e.g., flow control branch 812, EFU 814, ALU 816, ALU 818, TEX 820, and LDST 822).

FIG. 8 illustrates that SP 810 includes wave slots 860 and wave slots 870. In some aspects, the wave slots 860 and wave slots 870 may be referred to as flat wave slots, as each of the wave slots 860 and wave slots 870 may execute wave instructions on an individual basis without regard for the other wave slots. When an individual wave instruction is processing through the system, the corresponding wave slot may wait for the wave instruction to return (i.e., the wave slot can be in standby mode). Additionally, the context registers used in the wave slot logic may control wave execution and be flop-based, such as to enable switching between wave slots in order to access different EUs. As such, these context registers may need to be updated.

In some aspects, as shown in FIG. 8, a higher number of the number of wave slots can utilize a cross bar with an increased scaling ability between the wave slots and the execution units. For example, in SP 810, data cross bar 830 may need an increased scaling ability to increase the number of wave slots 860 and wave slots 870, which may result in a larger data cross bar 830. For example, SP 810 includes wave slots 860 and wave slots 870 and execution units (e.g., flow control branch 812, EFU 814, ALU 816, ALU 818, TEX 820, and LDST 822), so the data cross bar 830 may help to convert and manage this wave slot to execution unit ratio. So the data cross bar 830 can scale the number of wave instructions for every execution unit. Accordingly, if the number of wave slots is increased, then the data cross bar 830 may need to be adjusted to convert a different amount of wave slot instructions to the execution units.

FIG. 8 illustrates an example of a wave scheduler, which includes wave slots (aka Hwave slots) and execution slots (aka Eslots), as well as a wave slot queue, and execution slot queue hierarchy, an instruction scheduling arbiter, and execution units (e.g., a decoder). Wave slot context registers may store information, such as instruction program counter (PC), fiber coverage mask, shader type, etc., which is associated with input data. Once a wave slot is ready to execute an instruction, a wave scheduler may copy the wave slot context registers to an execution slot. After this, the wave scheduler may start to dispatch instructions to corresponding execution units, track an instruction execution, synchronize data dependency, switch out stalled waves (i.e., waves that are waiting for data to return from external memory) from an execution slot to a wave slot queue. The wave scheduler may also switch in ready wave slots to an execution slot.

In some aspects, the execution throughput for each execution unit may be different. In one example shader system, for a wave with 64 fibers, an ALU (e.g., ALU 816 or ALU 818) may process one scalar ALU instruction with 64 fibers in one cycle, and an EFU (e.g., EFU 814) may process 8 fibers in one cycle. As such, 64 fibers may take 8 cycles to complete. In some instances, a TEX (e.g., TEX 820) may generally takes 8-16 cycles to process 64 fibers, and a LDST (e.g., LDST 822) may take 16 cycles to process 64 fibers. As an execution cycle may issue instructions one-by-one, a program counter (PC) instruction (e.g., PC+1) may need to wait for another instruction (e.g., PC+0) to be issued, even if the instructions (e.g., PC+0 and PC+1) are different instruction types and could be issued to different execution units. This may create an issue if all execution slots are waiting to issue the same type of slow instructions (e.g., EFU 814, TEX 820, and LDST 822), as this blocks subsequent non-dependent instructions to other execution units for many cycles, as well as impairs execution slot efficiency.

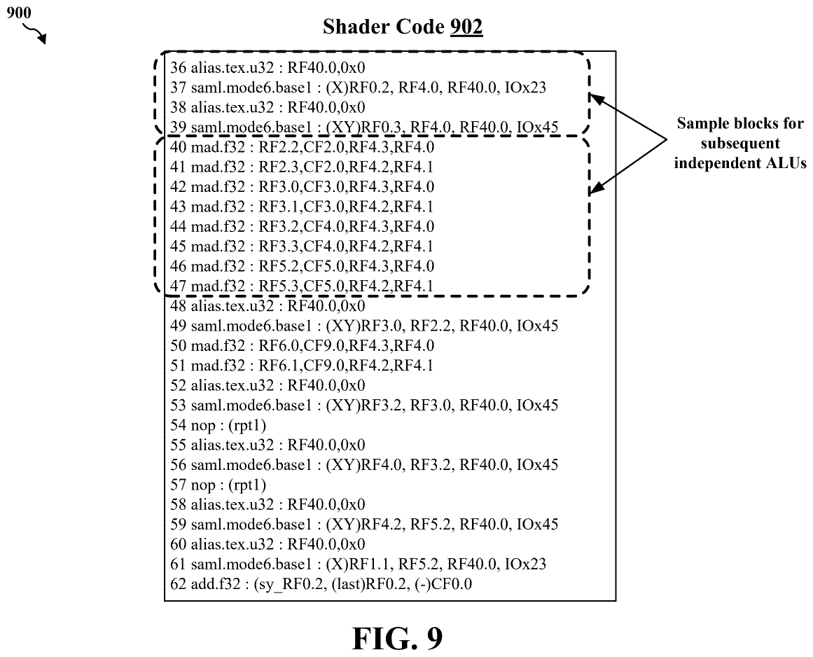

FIG. 9 illustrates diagram 900 including example shader code. More specifically, diagram 900 depicts one example of shader code that is processed at a GPU. As shown in FIG. 9, diagram 900 includes shader code 902 including a number of instructions (e.g., instruction PC 36 through instruction PC 62). FIG. 9 depicts that instructions PC 36-39 correspond to a sample block for a subsequent ALU. Also, instructions PC 40-47 correspond to another sample block for another subsequent ALU. That is, instructions PC 36-39 and instructions PC 40-47 may correspond to different sample blocks are subsequent, independent ALUs.

As shown in FIG. 9, in the example shader code 902 sequence, a first execution slot (e.g., execution slot 0) may issue instruction PC 37 to a TP engine and wait to issue instruction PC 39. A second execution slot (e.g., execution slot 1) may also be waiting to issue instruction PC 37 (i.e., both execution slot 0 and execution slot 1 are stalled). This may occur even though instruction PC 40 to instruction PC 47 (e.g., ALU instructions) have no dependency with instruction PC 37 and instruction PC 39. In some aspects, a wave scheduler may add a buffer between an execution slot queue and execution units (i.e., where throughput is low), but this may create another performance problem as the buffer may allow other waves to issue instructions and increase the chances of interleaving instructions from different waves. As the result, the synchronization overhead may increase. In the previous example, a second execution slot (e.g., execution slot 1) may issue instruction PC 37 ahead of first execution slot (e.g., execution slot 0) issuing instruction PC 39. The interleaving between waves may generally hurt TP cache data locality (hence increasing power) and increase internal/external data synchronization overhead at the SP. Issuing another instruction (e.g., an EFU, texture or load (LD) instruction) back-to-back within the same wave (e.g., a minimum granularity wave) may be more suitable.

As indicated above, because execution slots issue instruction one-by-one, if all execution slots are waiting to issue the same type of instructions, this may block subsequent non-dependent instructions to other execution units for many cycles, and thus impairs execution slot efficiency. In order to combat this issue, the wave scheduler may add buffer between an execution slot queue and execution units, but this creates another performance problem as the buffer may allow other waves to issue instructions and increase the chance of interleaving instructions from different waves, which may result in the synchronization overhead increasing. That is, when the execution slots are issuing instructions one-by-one, the program counters (PCs) may need to wait for each program counter that is in front of it, even if they are different types of instructions. As such, this creates a backup of instructions. Also, other types of solutions (e.g., adding a buffer) may cause the instructions to be issued out of order. Based on the above, it may be beneficial to reduce a backlog for shader instructions at a GPU. Also, it may be beneficial to ensure that instructions are issued in a correct order at a GPU.

Aspects of the present disclosure may help to alleviate a data or instruction backlog. For example, aspects presented herein may reduce a backlog for data or instructions (e.g., shader instructions) at a GPU. Aspects presented herein may also ensure that data or instructions are issued in a correct order. For instance, aspects of the present disclosure may verify that data or instructions (e.g., shader instructions) are issued in a correct order at a GPU. That is, aspects presented herein may arrange a set of instructions or data in a priority order. For example, aspects presented herein may arrange instructions or data based on a wave priority for the instructions and/or an instruction priority. Also, aspects presented herein may select at least one instruction for execution that includes a highest priority in the priority order. By doing so, aspects presented herein may allow lower priority waves to issue certain instructions (e.g., slow instructions) and free up subsequent independent instructions. This may alleviate a burden on a compiler to generate back-to-back instructions. Further, aspects presented herein may improve parallel execution and execution slot utilization at GPUs.

Aspects of the present disclosure may utilize an instruction queue or an instruction buffer for certain instructions (e.g., shader instructions). This instruction queue or instruction buffer may be managed based on a certain priority (e.g., a wave priority and/or an instruction priority). That is, the instruction queue or buffer may not be managed as a traditional queue or buffer (e.g., first-in, first-out (FIFO) or last-in, first-out (LIFO)), but rather based on a priority of the instructions. So aspects presented herein may generate an instruction queue for certain instructions (e.g., shader instructions) based on a priority order for the instructions. Aspects presented herein may also arrange, in the priority order, each of the instructions in the instruction queue. After doing so, aspects presented herein may select (or reselect) so each of the instructions based on the priority (e.g., a wave priority and/or an instruction priority). So even if all of the instructions are issued, they may be issued based on the wave priority and/or an instruction priority. Indeed, aspects presented herein may still be able to issue instructions back-to-back, as the priority information is utilized at the instruction queue. For instance, the back-to-back issuance of instructions may not cause a backlog or backup of instructions, as the instructions are issued based on the priority (e.g., a wave priority and/or an instruction priority). Hence, the selection of the instructions from a highest priority wave to a lowest priority wave may ease or alleviate any potential backlog, as well as improve the parallel execution at the GPU.

Additionally, by executing instructions based on a wave priority and/or an instruction priority, aspects presented herein may maintain the issuance of instructions back-to-back. That is, the backlog of instructions may be alleviated, so there is no further backlog caused when instructions are issued consecutively. Indeed, aspects presented herein may enable the parallel execution process because the instructions are issued in a correct order to ease instruction backlog (e.g., issued in a wave priority order and/or an instruction priority order). For example, unrelated instructions may be added into the queue, as the instructions are selected an executed in a proper order (e.g., an order based on the wave priority and/or an instruction priority). For instance, certain instructions may be added to the instruction queue, and then other instructions may be selected and executed based on a wave priority and/or an instruction priority. So subsequent, non-dependent area instructions may be issued immediately after the instruction is added to the to the queue, as they may be high priority instructions. Accordingly, aspects presented herein may be able to issue the certain types of instructions (e.g., sampling instructions) earlier than expected based on the priority order of the instructions. Also, aspects presented herein may enable the execution of instructions in a parallel and efficient fashion. This may result in a lower overhead for execution instructions, as well as a reduced backlog of instructions that are waiting to be executed. So aspects presented herein may be able to maintain issuing consecutive instructions without any wait between instructions. For example, aspects presented herein may allow GPUs to execute a subsequent instruction directly after a slow instruction without any increased backlog.

In some instances, as indicated herein, aspects presented herein may issue instructions based on the priority (e.g., a wave priority and/or an instruction priority). These instructions may be stored in an instruction queue in the priority order. When the instructions are selected for execution within the instruction queue, they are selected based on the priority order (e.g., a wave priority and/or an instruction priority). This priority order may also be referred to as a hierarchy (e.g., a wave hierarchy). Aspects presented herein may also sort each of the instructions for the entire shader program (e.g., sorted in a priority order). Further, aspects presented herein may select (or reselect) the instructions based on the priority order or instruction type. In some aspects, there may be another instruction queue that is based on the instruction type. Aspects presented herein may then use the priority (e.g., wave priority and/or an instruction priority) to sort this instruction queue. That is, aspects presented herein may sort (i.e., arrange or reorder) each of the instructions based on the priority.

As indicated herein, aspects presented herein may utilize an instruction queue or an instruction reorder queue in order to alleviate a backlog of instructions. Aspects presented herein may also implement the instruction queue or an instruction reorder queue in order to address certain types of execution engines (e.g., slow execution engines) that may cause an instruction backlog at a GPU. So aspects presented herein may alleviate certain the execution slots from dealing with an instruction backlog. For example, if there is an instruction backlog, these backlogged instructions may also block or other type of instructions. Aspects presented herein may alleviate any potential instruction backlog and thus reduce any potential errors. Further, aspects presented herein may allow GPUs to achieve maximum parallelism and greater efficiency during instruction execution.

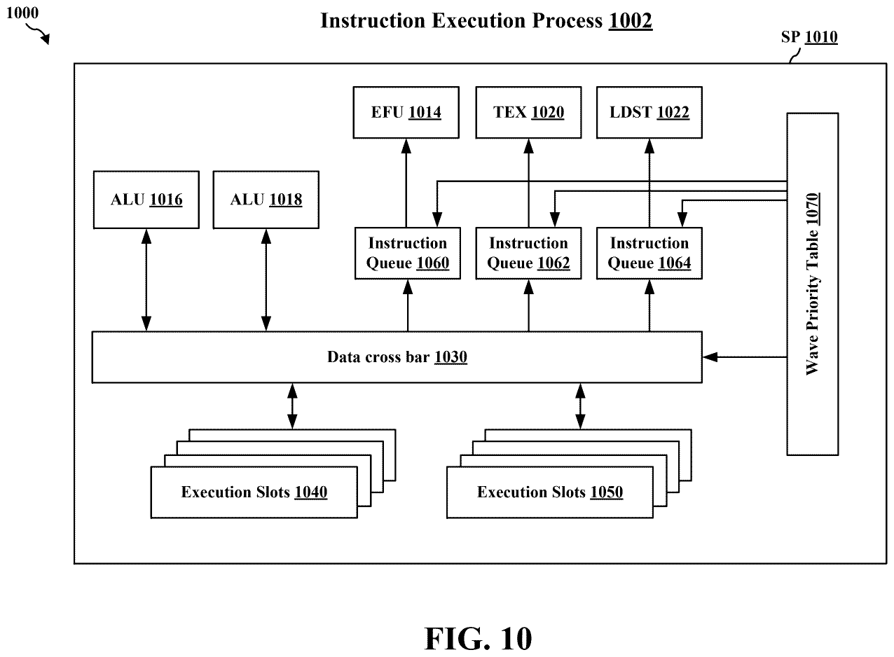

FIG. 10 illustrates diagram 1000 including an example instruction execution process. More specifically, diagram 1000 depicts one example of an instruction execution process 1002 within SP 1010 at a GPU. As shown in FIG. 10, diagram 1000 includes a number of execution units (e.g., EFU 1014 (e.g., 16 EFUs), ALU 1016 (e.g., 64 ALUs), ALU 1018 (e.g., 64 ALUs), TEX 1020 (e.g., 8 TEXs), and LDST 1022 (e.g., 16 LDSTs). SP 1010 may include a number of additional execution units, as execution units 1014-1022 are merely an example and any combination or order of execution units can be used by GPUs herein. SP 1010 may also include data cross bar 1030, which can also be referred to as multiple thread manager and/or a level zero (L0) cache. SP 1010 also includes execution slots 1040 (e.g., 64 fibers) and execution slots 1050 (e.g., 64 fibers). SP 1010 may include any number of different wave slots (not shown). In some aspects, the wave slots may be part of a wave scheduler. Each component in SP 1010 may communicate with a number of other components. For instance, each of the execution units (e.g., EFU 1014, ALU 1016, ALU 1018, TEX 1020, and LDST 1022) may send or receive data or instructions (e.g., requests or grants) to/from the data cross bar 1030. Also, each of the wave slots (not shown) may send or receive data or instructions (e.g., requests or grants) to/from the execution slots 1040 or the execution slots 1050. Each of the execution units (e.g., EFU 1014, ALU 1016, ALU 1018, TEX 1020, and LDST 1022) may also send or receive data or instructions to/from the wave slots. In some aspects, each of the wave slots may issue instructions simultaneously to each of the execution units (e.g., EFU 1014, ALU 1016, ALU 1018, TEX 1020, and LDST 1022).

As shown in FIG. 10, SP 1010 may also include a number of instruction queues (e.g., instruction queue 1060, instruction queue 1062, and instruction queue 1064). SP 1010 may also include a wave priority table 1070. For instance, the wave priority table 1070 may communicate priority information (e.g., wave priority information and/or instruction priority information) with each of the instruction queues (e.g., instruction queue 1060, instruction queue 1062, and instruction queue 1064). Also, the instruction queues (e.g., instruction queue 1060, instruction queue 1062, and instruction queue 1064) may communicate with the execution units. For example, instruction queue 1060 may communication with EFU 1014, instruction queue 1062 may communication with TEX 1020, and instruction queue 1064 may communicate with LDST 1022. Further, the data cross bar 1030 may communicate with each of the instruction queues (e.g., instruction queue 1060, instruction queue 1062, and instruction queue 1064). Moreover, the wave priority table 1070 may communicate with the data cross bar. Accordingly, the wave priority table 1070 and each of the instruction queues (e.g., instruction queue 1060, instruction queue 1062, and instruction queue 1064) may be able to communicate with the data cross bar 1030 and/or the execution units (e.g., EFU 1014, TEX 1020, and LDST 1022).

As shown in FIG. 10, SP 1010 may issue instructions based on the priority (e.g., a wave priority and/or an instruction priority) from wave priority table 1070. These instructions may be stored in instruction queues (e.g., instruction queue 1060, instruction queue 1062, and instruction queue 1064) in the priority order. When the instructions are selected for execution within the instruction queues (e.g., instruction queue 1060, instruction queue 1062, and instruction queue 1064), they are selected based on the priority order (e.g., a wave priority and/or an instruction priority from wave priority table 1070). This priority order may also be referred to as a hierarchy (e.g., a wave hierarchy from wave priority table 1070). SP 1010 may also sort each of the instructions for the entire shader program (e.g., sorted in a priority order from wave priority table 1070). Further, SP 1010 may select (or reselect) the instructions based on the priority order (e.g., from wave priority table 1070) or instruction type. In some aspects, SP 1010 may include instruction queues (e.g., instruction queue 1060, instruction queue 1062, and instruction queue 1064) that are based on an instruction type. SP 1010 may then use the priority (e.g., wave priority and/or instruction priority from wave priority table 1070) to sort the instruction queues (e.g., instruction queue 1060, instruction queue 1062, and instruction queue 1064). That is, SP 1010 may sort (i.e., arrange or reorder) each of the instructions in the instruction queues (e.g., instruction queue 1060, instruction queue 1062, and instruction queue 1064) based on the priority (e.g., the wave priority and/or instruction priority from wave priority table 1070).

As depicted in FIG. 10, the SP 1010 or wave scheduler may generate a priority hierarchy, such as via instruction queues (e.g., instruction queue 1060, instruction queue 1062, and instruction queue 1064). For instance, the SP 1010 or wave scheduler may build a second level (e.g., 2-level) of an arbitrations hierarchy between the execution slots (e.g., execution slots 1040 and execution slots 1050) and certain execution units (e.g., EFU 1014, TEX 1020, and LDST 1022), which may be slower at processing than other execution units (e.g., ALU 1016 and ALU 1018). The SP 1010 or wave scheduler may also add an instruction queue (e.g., instruction queue 1060, instruction queue 1062, and instruction queue 1064, such as a reorder instruction queue) between a first level arbiter (e.g., data cross bar 1030) and certain execution units (e.g., EFU 1014, TEX 1020, and LDST 1022). By doing so, the SP 1010 or wave scheduler may reorder dispatched instructions in the instruction queue (e.g., instruction queue 1060, instruction queue 1062, and instruction queue 1064) based on an instruction priority level (by set priority instructions) and a wave priority in order to select an instruction from the queue. For example, the SP 1010 or wave scheduler may select a highest priority instruction from the instruction queue (e.g., instruction queue 1060, instruction queue 1062, and instruction queue 1064) based on a priority order (e.g., from the wave priority table 1070). The highest priority instruction from the instruction queue (e.g., instruction queue 1060, instruction queue 1062, and instruction queue 1064) may then be executed accordingly.

Additionally, the SP 1010 or wave scheduler may manage the entries to the instruction queue (e.g., instruction queue 1060, instruction queue 1062, and instruction queue 1064) as a credit pool. The SP 1010 or wave scheduler may also reserve at least one slot for a highest priority wave (e.g., based on the wave priority table 1070) and reserve sufficient credits for low priority waves. For instance, if an instruction queue is a certain depth (e.g., insQ depth=8), the SP 1010 or wave scheduler may reserve a certain amount of depth (e.g., 4). By doing so, this allows high priority waves to issue subsequent instructions of the same type, so the late arriving instruction from high priority waves can be reordered and issued as back-to-back instructions. In the meantime, the SP 1010 or wave scheduler may allow instructions from lower priority waves to be issued to the instruction queue (e.g., instruction queue 1060, instruction queue 1062, and instruction queue 1064) for waiting, and thus alleviate subsequent, non-dependent instructions. In one example, a first execution slot (Eslot 0) may issue a certain instruction (e.g., instruction PC 37), then a second execution slot (Eslot 1) may issue a similar instruction (e.g., instruction PC 37), then the first execution slot (Eslot 0) may issue another instruction (e.g., instruction PC 39). After doing so, the reordered instruction queue (e.g., instruction queue 1060, instruction queue 1062, and instruction queue 1064) may be able to prioritize instruction PC 39 of the first execution slot (Eslot 0) over instruction PC 37 of second execution slot (Eslot 1). Thus, instruction PC 37 and instruction PC 39 may be issued consecutively (i.e., back-to-back). Further, both first execution slot (Eslot 0) and second execution slot (Eslot 1) may continue to issue other instructions (e.g., instruction PC 40 through instruction PC47) after second execution slot (Eslot 1) issues instruction PC 39 to the instruction queue (e.g., instruction queue 1060, instruction queue 1062, and instruction queue 1064).

As shown in FIG. 10, SP 1010 or wave scheduler may obtain a set of instructions associated with the graphics processing. Also, SP 1010 or wave scheduler may determine (e.g., determine at instruction queue 1060, instruction queue 1062, and instruction queue 1064) a priority order for each of the set of instructions associated with the graphics processing (e.g., based on the priority order from wave priority table 1070). Further, SP 1010 or wave scheduler may identify (e.g., identify at instruction queue 1060, instruction queue 1062, and instruction queue 1064) at least one instruction in the set of instructions based on the priority order for each of the set of instructions (e.g., based on the priority order from wave priority table 1070). Additionally, SP 1010 or wave scheduler may execute the at least one instruction based on identification of the at least one instruction (e.g., based on the priority order from wave priority table 1070).

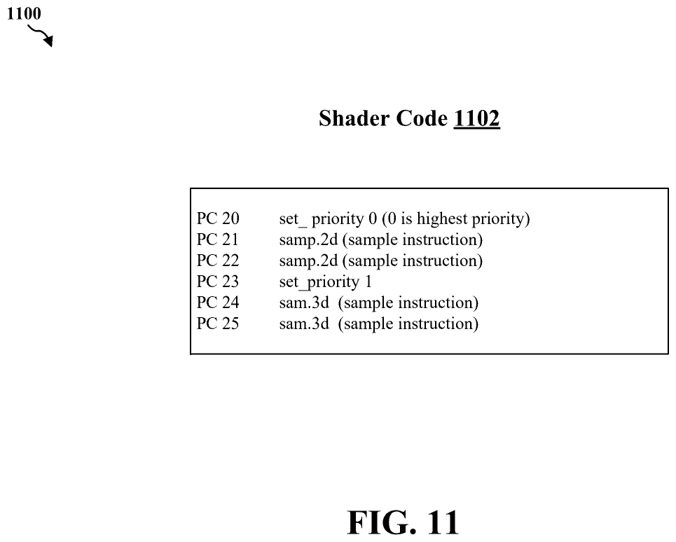

FIG. 11 illustrates diagram 1100 including example shader code. More specifically, diagram 1100 depicts one example of shader code 1102 that is processed at a GPU. As shown in FIG. 11, diagram 1100 includes shader code 1102 including a number of instructions (e.g., instruction PC 20 through instruction PC 25). FIG. 11 depicts that there may be an instruction priority element for a wave priority table (e.g., wave priority table 1070 in FIG. 10). In one example, there may be a number of instructions: PC 20 (e.g., “set_priority 0” (0 is highest priority)), PC 21 (e.g., “samp.2d” (sample instruction)), PC 22 (e.g., “samp.2d” (sample instruction)), PC 23 (e.g., “set_priority 1”), PC 24 (e.g., “sam.3d” (sample instruction)), PC25 (e.g., “sam.3d” (sample instruction)). In the example sequence above in FIG. 11, wave 0may have a higher priority than wave 1. If instruction queue 1062 includes wave 0instruction PC 24 and PC 25 and wave 1 instruction PC 21 and 22, then wave 1 PC 21 and 22 may be issued earlier than wave 0 PC 24 and PC 25. As such, priority for the wave priority table (e.g., wave priority table 1070 in FIG. 10) may be selected in order of instruction priority, as well as wave priority. As shown in FIG. 11, an instruction priority may take a higher priority than a wave priority. For example, in a re-order queue (e.g., an insQ re-order queue), there may be both high priority instructions and low priority instructions. An arbiter (e.g., an insQ arbiter) may select one winner from a high priority queue and one winner from a low priority queue. In some instances, the high priority winner may trump the low priority winner.

Aspects of the present disclosure may include a number of benefits or advantages. For instance, aspects of the present disclosure may help to alleviate a data or instruction backlog. For example, aspects presented herein may reduce a backlog for data or instructions (e.g., shader instructions) at a GPU. Aspects presented herein may also ensure that data or instructions are issued in a correct order. For instance, aspects of the present disclosure may verify that data or instructions (e.g., shader instructions) are issued in a correct order at a GPU. That is, aspects presented herein may arrange a set of instructions or data in a priority order. For example, aspects presented herein may arrange instructions or data based on a wave priority for the instructions. Also, aspects presented herein may select at least one instruction for execution that includes a highest priority in the priority order. By doing so, aspects presented herein may allow lower priority waves to issue certain instructions (e.g., slow instructions) and free up subsequent independent instructions. This may alleviate a burden on a compiler to generate back-to-back instructions. Further, aspects presented herein may improve parallel execution and execution slot utilization at GPUs. Also, aspects presented herein may allow an SP scheduler to restore back-to-back EFU/Texture/LD execution through reordering an instruction queue, even though a compiler does not place these instructions back-to-back. Also, aspects presented herein may enable lower priority waves to issue slow instructions to an instruction queue and free up subsequent independent instructions early, in order to improve parallel execution and Eslot utilization.

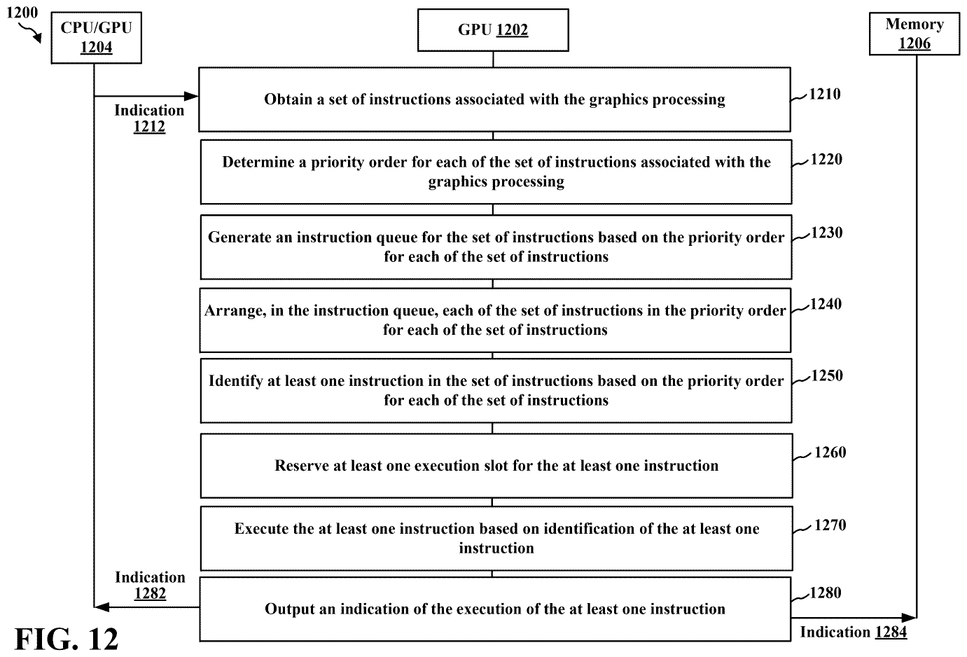

FIG. 12 is a communication flow diagram 1200 of graphics processing in accordance with one or more techniques of this disclosure. As shown in FIG. 12, diagram 1200 includes example communications between GPU 1202 (e.g., a GPU, a graphics pipeline at a GPU, a shader processor at a GPU, a streaming processor at a GPU, a GPU component, another graphics processor, a CPU, a CPU component, or another central processor), CPU/GPU 1204 (e.g., a CPU, a CPU component, or another central processor, a GPU, a graphics pipeline at a GPU, a shader processor at a GPU, a GPU component, or another graphics processor), and memory 1206 (e.g., a memory, a cache, a system memory, a graphics memory, a memory or cache at a CPU, or a memory or cache at a GPU), in accordance with one or more techniques of this disclosure.

At 1210, GPU 1202 may obtain a set of instructions associated with the graphics processing. For example, GPU 1202 may obtain indication 1212 from CPU/GPU 1204. In some aspects, the set of instructions may be a set of shader instructions associated with shader code for the graphics processing. Also, the set of instructions may be associated with a wave at a graphics processing unit (GPU).

At 1220, GPU 1202 may determine a priority order for each of the set of instructions associated with the graphics processing. In some aspects, determining the priority order for each of the set of instructions may comprise: determining the priority order for each of the set of instructions based on a wave priority for each of the set of instructions. The wave priority for each of the set of instructions may be based on a seniority of each of the set of instructions. Also, the wave priority for each of the set of instructions may be based on an instruction importance level of each of the set of instructions. In some aspects, the instruction importance level of each of the set of instructions may be based on at least one of: a wave lifespan of each of the set of instructions, a latency of each of the set of instructions, or a resource condition for each of the set of instructions. In some aspects, determining the priority order for each of the set of instructions may comprise: arranging each of the set of instructions in the priority order. Also, arranging each of the set of instructions in the priority order may comprise: arranging each of the set of instructions in the priority order based on a wave priority for each of the set of instructions. Moreover, the priority order for each of the set of instructions may be based on a user-defined order for each of the set of instructions or a compiler-defined order for each of the set of instructions.

At 1230, GPU 1202 may generate an instruction queue for the set of instructions based on the priority order for each of the set of instructions. In some aspects, the instruction queue for the set of instructions may include at least one of the set of instructions, a wave identifier (ID) for each of the set of instructions, or importance information for each of the set of instructions. Also, generating the instruction queue for the set of instructions may comprise: generating the instruction queue for the set of instructions at a streaming processor (SP) in a graphics processing unit (GPU) or a scheduler of the SP.

At 1240, GPU 1202 may arrange, in the instruction queue, each of the set of instructions in the priority order for each of the set of instructions.

At 1250, GPU 1202 may identify at least one instruction in the set of instructions based on the priority order for each of the set of instructions. In some aspects, identifying the at least one instruction based on the priority order for each of the set of instructions may comprise: selecting the at least one instruction based on the priority order for each of the set of instructions. Also, selecting the at least one instruction based on the priority order may comprise: selecting the at least one instruction that includes a highest priority in the priority order. Further, one or more other instructions in the set of instructions may include a lower priority in the priority order compared to the at least one instruction.

At 1260, GPU 1202 may reserve at least one execution slot for the at least one instruction. In some aspects, reserving the at least one execution slot for the at least one instruction may comprise: reserving the at least one execution slot for the at least one instruction; and entering, in an instruction queue, one or more remaining instructions in the set of instructions.

At 1270, GPU 1202 may execute the at least one instruction based on identification of the at least one instruction. Further, in some aspects, executing the at least one instruction may comprise executing the at least one instruction in the at least one execution slot.

At 1280, GPU 1202 may output an indication of the execution of the at least one instruction based on the identification of the at least one instruction. In some aspects, outputting the indication of the execution of the at least one instruction may comprise: transmitting the indication of the execution of the at least one instruction. For example, GPU 1202 may transmit indication 1282 to CPU/GPU 1204. Also, outputting the indication of the execution of the at least one instruction may comprise: storing the indication of the execution of the at least one instruction. For example, GPU 1202 may store indication 1284 in memory 1206.

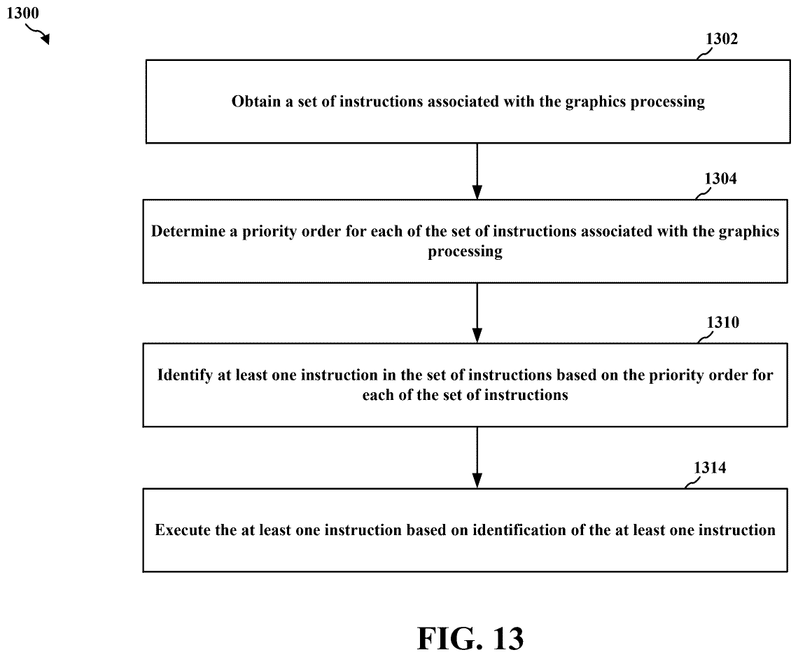

FIG. 13 is a flowchart 1300 of an example method of graphics processing in accordance with one or more techniques of this disclosure. The method may be performed by a GPU (e.g., a GPU, a graphics pipeline at a GPU, a shader processor at a GPU, a streaming processor at a GPU, a GPU component, another graphics processor, a CPU, a CPU component, or another central processor), a CPU/GPU (e.g., a CPU, a CPU component, another central processor, a GPU, a shader processor at a GPU, a streaming processor at a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-12.

At 1302, the GPU may obtain a set of instructions associated with the graphics processing, as described in connection with the examples in FIGS. 1-12. For example, as described in 1210 of FIG. 12, GPU 1202 may obtain a set of instructions associated with the graphics processing. Further, step 1302 may be performed by processing unit 120 in FIG. 1. For example, GPU 1202 may obtain indication 1212 from CPU/GPU 1204. In some aspects, the set of instructions may be a set of shader instructions associated with shader code for the graphics processing. Also, the set of instructions may be associated with a wave at a graphics processing unit (GPU).

At 1304, the GPU may determine a priority order for each of the set of instructions associated with the graphics processing, as described in connection with the examples in FIGS. 1-12. For example, as described in 1220 of FIG. 12, GPU 1202 may determine a priority order for each of the set of instructions associated with the graphics processing. Further, step 1304 may be performed by processing unit 120 in FIG. 1. In some aspects, determining the priority order for each of the set of instructions may comprise: determining the priority order for each of the set of instructions based on a wave priority for each of the set of instructions. The wave priority for each of the set of instructions may be based on a seniority of each of the set of instructions. Also, the wave priority for each of the set of instructions may be based on an instruction importance level of each of the set of instructions. In some aspects, the instruction importance level of each of the set of instructions may be based on at least one of: a wave lifespan of each of the set of instructions, a latency of each of the set of instructions, or a resource condition for each of the set of instructions. In some aspects, determining the priority order for each of the set of instructions may comprise: arranging each of the set of instructions in the priority order. Also, arranging each of the set of instructions in the priority order may comprise: arranging each of the set of instructions in the priority order based on a wave priority for each of the set of instructions. Moreover, the priority order for each of the set of instructions may be based on a user-defined order for each of the set of instructions or a compiler-defined order for each of the set of instructions.

At 1310, the GPU may identify at least one instruction in the set of instructions based on the priority order for each of the set of instructions, as described in connection with the examples in FIGS. 1-12. For example, as described in 1250 of FIG. 12, GPU 1202 may identify at least one instruction in the set of instructions based on the priority order for each of the set of instructions. Further, step 1310 may be performed by processing unit 120 in FIG. 1. In some aspects, identifying the at least one instruction based on the priority order for each of the set of instructions may comprise: selecting the at least one instruction based on the priority order for each of the set of instructions. Also, selecting the at least one instruction based on the priority order may comprise: selecting the at least one instruction that includes a highest priority in the priority order. Further, one or more other instructions in the set of instructions may include a lower priority in the priority order compared to the at least one instruction.

At 1314, the GPU may execute the at least one instruction based on identification of the at least one instruction, as described in connection with the examples in FIGS. 1-12. For example, as described in 1270 of FIG. 12, GPU 1202 may execute the at least one instruction based on identification of the at least one instruction. Further, step 1314 may be performed by processing unit 120 in FIG. 1. Further, in some aspects, executing the at least one instruction may comprise executing the at least one instruction in the at least one execution slot.

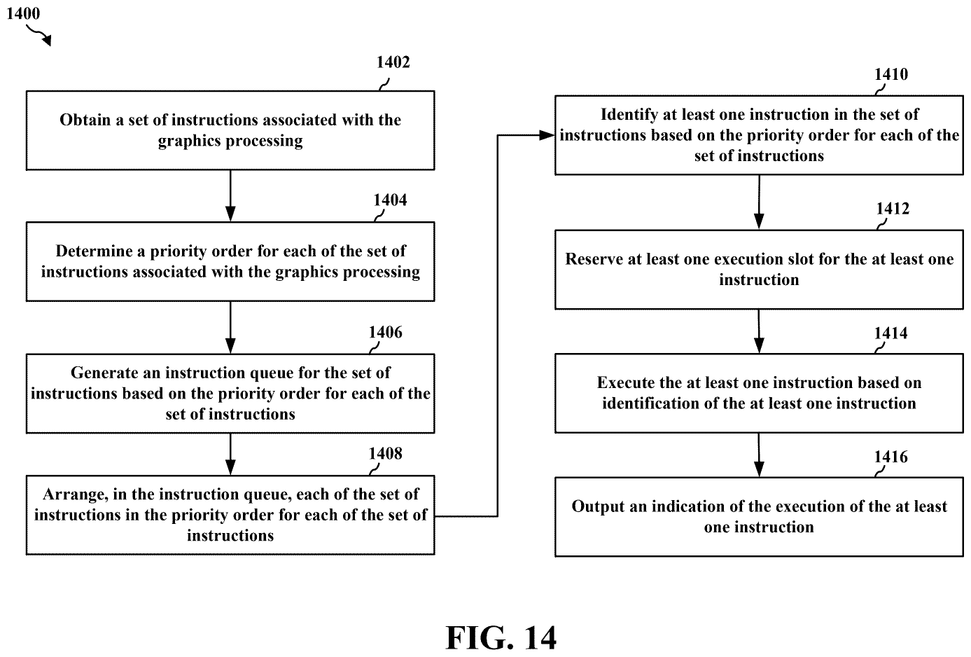

FIG. 14 is a flowchart 1400 of an example method of graphics processing in accordance with one or more techniques of this disclosure. The method may be performed by a GPU (e.g., a GPU, a graphics pipeline at a GPU, a shader processor at a GPU, a streaming processor at a GPU, a GPU component, another graphics processor, a CPU, a CPU component, or another central processor), a CPU/GPU (e.g., a CPU, a CPU component, another central processor, a GPU, a shader processor at a GPU, a streaming processor at a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-12.

At 1402, the GPU may obtain a set of instructions associated with the graphics processing, as described in connection with the examples in FIGS. 1-12. For example, as described in 1210 of FIG. 12, GPU 1202 may obtain a set of instructions associated with the graphics processing. Further, step 1402 may be performed by processing unit 120 in FIG. 1. For example, GPU 1202 may obtain indication 1212 from CPU/GPU 1204. In some aspects, the set of instructions may be a set of shader instructions associated with shader code for the graphics processing. Also, the set of instructions may be associated with a wave at a graphics processing unit (GPU).

At 1404, the GPU may determine a priority order for each of the set of instructions associated with the graphics processing, as described in connection with the examples in FIGS. 1-12. For example, as described in 1220 of FIG. 12, GPU 1202 may determine a priority order for each of the set of instructions associated with the graphics processing. Further, step 1404 may be performed by processing unit 120 in FIG. 1. In some aspects, determining the priority order for each of the set of instructions may comprise: determining the priority order for each of the set of instructions based on a wave priority for each of the set of instructions. The wave priority for each of the set of instructions may be based on a seniority of each of the set of instructions. Also, the wave priority for each of the set of instructions may be based on an instruction importance level of each of the set of instructions. In some aspects, the instruction importance level of each of the set of instructions may be based on at least one of: a wave lifespan of each of the set of instructions, a latency of each of the set of instructions, or a resource condition for each of the set of instructions. In some aspects, determining the priority order for each of the set of instructions may comprise: arranging each of the set of instructions in the priority order. Also, arranging each of the set of instructions in the priority order may comprise: arranging each of the set of instructions in the priority order based on a wave priority for each of the set of instructions. Moreover, the priority order for each of the set of instructions may be based on a user-defined order for each of the set of instructions or a compiler-defined order for each of the set of instructions.

At 1406, the GPU may generate an instruction queue for the set of instructions based on the priority order for each of the set of instructions, as described in connection with the examples in FIGS. 1-12. For example, as described in 1230 of FIG. 12, GPU 1202 may generate an instruction queue for the set of instructions based on the priority order for each of the set of instructions. Further, step 1406 may be performed by processing unit 120 in FIG. 1. In some aspects, the instruction queue for the set of instructions may include at least one of the set of instructions, a wave identifier (ID) for each of the set of instructions, or importance information for each of the set of instructions. Also, generating the instruction queue for the set of instructions may comprise: generating the instruction queue for the set of instructions at a streaming processor (SP) in a graphics processing unit (GPU) or a scheduler of the SP.

At 1408, the GPU may arrange, in the instruction queue, each of the set of instructions in the priority order for each of the set of instructions, as described in connection with the examples in FIGS. 1-12. For example, as described in 1240 of FIG. 12, GPU 1202 may arrange, in the instruction queue, each of the set of instructions in the priority order for each of the set of instructions. Further, step 1408 may be performed by processing unit 120 in FIG. 1.

At 1410, the GPU may identify at least one instruction in the set of instructions based on the priority order for each of the set of instructions, as described in connection with the examples in FIGS. 1-12. For example, as described in 1250 of FIG. 12, GPU 1202 may identify at least one instruction in the set of instructions based on the priority order for each of the set of instructions. Further, step 1410 may be performed by processing unit 120 in FIG. 1. In some aspects, identifying the at least one instruction based on the priority order for each of the set of instructions may comprise: selecting the at least one instruction based on the priority order for each of the set of instructions. Also, selecting the at least one instruction based on the priority order may comprise: selecting the at least one instruction that includes a highest priority in the priority order. Further, one or more other instructions in the set of instructions may include a lower priority in the priority order compared to the at least one instruction.

At 1412, the GPU may reserve at least one execution slot for the at least one instruction, as described in connection with the examples in FIGS. 1-12. For example, as described in 1260 of FIG. 12, GPU 1202 may reserve at least one execution slot for the at least one instruction. Further, step 1412 may be performed by processing unit 120 in FIG. 1. In some aspects, reserving the at least one execution slot for the at least one instruction may comprise: reserving the at least one execution slot for the at least one instruction; and entering, in an instruction queue, one or more remaining instructions in the set of instructions.

At 1414, the GPU may execute the at least one instruction based on identification of the at least one instruction, as described in connection with the examples in FIGS. 1-12. For example, as described in 1270 of FIG. 12, GPU 1202 may execute the at least one instruction based on identification of the at least one instruction. Further, step 1414 may be performed by processing unit 120 in FIG. 1. Further, in some aspects, executing the at least one instruction may comprise executing the at least one instruction in the at least one execution slot.

At 1416, the GPU may output an indication of the execution of the at least one instruction based on the identification of the at least one instruction, as described in connection with the examples in FIGS. 1-12. For example, as described in 1280 of FIG. 12, GPU 1202 may output an indication of the execution of the at least one instruction based on the identification of the at least one instruction. Further, step 1416 may be performed by processing unit 120 in FIG. 1. In some aspects, outputting the indication of the execution of the at least one instruction may comprise: transmitting the indication of the execution of the at least one instruction. For example, GPU 1202 may transmit indication 1282 to CPU/GPU 1204. Also, outputting the indication of the execution of the at least one instruction may comprise: storing the indication of the execution of the at least one instruction. For example, GPU 1202 may store indication 1284 in memory 1206.

In configurations, a method or an apparatus for graphics processing is provided. The apparatus may be a GPU (or other graphics processor), a CPU (or other central processor), a DDIC, an apparatus for graphics processing, and/or some other processor that may perform graphics processing. In aspects, the apparatus may be the processing unit 120 within the device 104, or may be some other hardware within the device 104 or another device. The apparatus, e.g., processing unit 120, may include means for obtaining a set of instructions associated with the graphics processing. The apparatus, e.g., processing unit 120, may also include means for determining a priority order for each of the set of instructions associated with the graphics processing. The apparatus, e.g., processing unit 120, may also include means for identifying at least one instruction in the set of instructions based on the priority order for each of the set of instructions. The apparatus, e.g., processing unit 120, may also include means for executing the at least one instruction based on identification of the at least one instruction. The apparatus, e.g., processing unit 120, may also include means for generating an instruction queue for the set of instructions based on the priority order for each of the set of instructions. The apparatus, e.g., processing unit 120, may also include means for arranging, in the instruction queue, each of the set of instructions in the priority order for each of the set of instructions. The apparatus, e.g., processing unit 120, may also include means for reserving at least one execution slot for the at least one instruction. The apparatus, e.g., processing unit 120, may also include means for outputting an indication of the execution of the at least one instruction based on the identification of the at least one instruction.

The subject matter described herein may be implemented to realize one or more benefits or advantages. For instance, the described graphics processing techniques may be used by a GPU, a shader processor, a streaming processor, a CPU, a central processor, or some other processor that may perform graphics processing to implement the instruction reordering techniques described herein. This may also be accomplished at a low cost compared to other graphics processing techniques. Moreover, the graphics processing techniques herein may improve or speed up data processing or execution. Further, the graphics processing techniques herein may improve resource or data utilization and/or resource efficiency. Additionally, aspects of the present disclosure may utilize instruction reordering techniques in order to improve memory bandwidth efficiency and/or increase processing speed at a GPU, a shader processor, a CPU, or a display processing unit (DPU).

It is understood that the specific order or hierarchy of blocks in the processes/flowcharts disclosed is an illustration of example approaches. Based upon design preferences, it is understood that the specific order or hierarchy of blocks in the processes / flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing, including at least one memory; and at least one processor coupled to the at least one memory and, based at least in part on information stored in the at least one memory, the at least one processor, individually or in any combination, is configured to: obtain a set of instructions associated with the graphics processing; determine a priority order for each of the set of instructions associated with the graphics processing; identify at least one instruction in the set of instructions based on the priority order for each of the set of instructions; and execute the at least one instruction based on identification of the at least one instruction.

Aspect 2 is the apparatus of aspect 1, wherein to determine the priority order for each of the set of instructions, the at least one processor, individually or in any combination, is configured to: determine the priority order for each of the set of instructions based on a wave priority for each of the set of instructions.

Aspect 3 is the apparatus of aspect 2, wherein the wave priority for each of the set of instructions is based on a seniority of each of the set of instructions.

Aspect 4 is the apparatus of any of aspects 2 to 3, wherein the wave priority for each of the set of instructions is based on an instruction importance level of each of the set of instructions.

Aspect 5 is the apparatus of aspect 4, wherein the instruction importance level of each of the set of instructions is based on at least one of: a wave lifespan of each of the set of instructions, a latency of each of the set of instructions, or a resource condition for each of the set of instructions.

Aspect 6 is the apparatus of any of aspects 1 to 5, wherein the at least one processor, individually or in any combination, is further configured to: generate an instruction queue for the set of instructions based on the priority order for each of the set of instructions.

Aspect 7 is the apparatus of aspect 6, wherein the at least one processor, individually or in any combination, is further configured to: arrange, in the instruction queue, each of the set of instructions in the priority order for each of the set of instructions.

Aspect 8 is the apparatus of any of aspects 6 to 7, wherein the instruction queue for the set of instructions includes at least one of: the set of instructions, a wave identifier (ID) for each of the set of instructions, or importance information for each of the set of instructions.

Aspect 9 is the apparatus of any of aspects 6 to 8, wherein to generate the instruction queue for the set of instructions, the at least one processor, individually or in any combination, is configured to: generate the instruction queue for the set of instructions at a streaming processor (SP) in a graphics processing unit (GPU) or a scheduler of the SP.

Aspect 10 is the apparatus of any of aspects 1 to 9, wherein the at least one processor, individually or in any combination, is further configured to: reserve at least one execution slot for the at least one instruction, wherein to execute the at least one instruction, the at least one processor, individually or in any combination, is configured to execute the at least one instruction in the at least one execution slot.

Aspect 11 is the apparatus of aspect 10, wherein to reserve the at least one execution slot for the at least one instruction, the at least one processor, individually or in any combination, is configured to: reserve the at least one execution slot for the at least one instruction; and enter, in an instruction queue, one or more remaining instructions in the set of instructions.

Aspect 12 is the apparatus of any of aspects 1 to 11, wherein to identify the at least one instruction based on the priority order for each of the set of instructions, the at least one processor, individually or in any combination, is configured to: select the at least one instruction based on the priority order for each of the set of instructions.

Aspect 13 is the apparatus of aspect 12, wherein to select the at least one instruction based on the priority order, the at least one processor, individually or in any combination, is configured to: select the at least one instruction that includes a highest priority in the priority order.

Aspect 14 is the apparatus of aspect 13, wherein one or more other instructions in the set of instructions include a lower priority in the priority order compared to the at least one instruction.

Aspect 15 is the apparatus of any of aspects 1 to 14, wherein to determine the priority order for each of the set of instructions, the at least one processor, individually or in any combination, is configured to: arrange each of the set of instructions in the priority order.

Aspect 16 is the apparatus of aspect 15, wherein to arrange each of the set of instructions in the priority order, the at least one processor, individually or in any combination, is configured to: arrange each of the set of instructions in the priority order based on a wave priority for each of the set of instructions.

Aspect 17 is the apparatus of any of aspects 1 to 16, wherein the priority order for each of the set of instructions is based on a user-defined order for each of the set of instructions or a compiler-defined order for each of the set of instructions.

Aspect 18 is the apparatus of any of aspects 1 to 17, wherein the set of instructions is a set of shader instructions associated with shader code for the graphics processing, and wherein the set of instructions is associated with a wave at a graphics processing unit (GPU).

Aspect 19 is the apparatus of any of aspects 1 to 18, wherein the at least one processor, individually or in any combination, is further configured to: output an indication of the execution of the at least one instruction based on the identification of the at least one instruction.

Aspect 20 is the apparatus of aspect 19, wherein to output the indication of the execution of the at least one instruction, the at least one processor, individually or in any combination, is configured to: transmit the indication of the execution of the at least one instruction; or store the indication of the execution of the at least one instruction.

Aspect 21 is the apparatus of aspect 20, wherein the apparatus is a wireless communication device, further including (i.e., comprising) at least one of an antenna or a transceiver coupled to the at least one processor, wherein to transmit the indication of the execution of the at least one instruction, the at least one processor is configured to: transmit, via at least one of the antenna or the transceiver, the indication of the execution of the at least one instruction.

Aspect 22 is a method of graphics processing for implementing any of aspects 1 to 21.

Aspect 23 is an apparatus for graphics processing including means for implementing any of aspects 1 to 21.

Aspect 24 is a computer-readable medium (e.g., a non-transitory computer-readable medium) storing computer executable code (e.g., code for graphics processing), the code when executed by a processor causes the processor to implement any of aspects 1 to 21.

1. An apparatus for graphics processing, comprising:
at least one memory; and
at least one processor coupled to the at least one memory and, based at least in part on information stored in the at least one memory, the at least one processor is configured to:
obtain a set of instructions associated with the graphics processing;
determine a priority order for each of the set of instructions associated with the graphics processing based on a wave priority for each of the set of instructions;
identify at least one instruction in the set of instructions based on the priority order for each of the set of instructions; and
execute the at least one instruction based on identification of the at least one instruction.

2. (canceled)

3. The apparatus of claim 1, wherein the wave priority for each of the set of instructions is based on a seniority of each of the set of instructions.

4. The apparatus of claim 1, wherein the wave priority for each of the set of instructions is based on an instruction importance level of each of the set of instructions.

5. The apparatus of claim 4, wherein the instruction importance level of each of the set of instructions is based on at least one of:
a wave lifespan of each of the set of instructions,
a latency of each of the set of instructions, or
a resource condition for each of the set of instructions.

6. The apparatus of claim 1, wherein the at least one processor is further configured to:
generate an instruction queue for the set of instructions based on the priority order for each of the set of instructions.

7. The apparatus of claim 6, wherein the at least one processor is further configured to:
arrange, in the instruction queue, each of the set of instructions in the priority order for each of the set of instructions.

8. The apparatus of claim 6, wherein the instruction queue for the set of instructions includes at least one of:
the set of instructions,
a wave identifier (ID) for each of the set of instructions, or
importance information for each of the set of instructions.

9. The apparatus of claim 6, wherein to generate the instruction queue for the set of instructions, the at least one processor is configured to:
generate the instruction queue for the set of instructions at a streaming processor (SP) in a graphics processing unit (GPU) or a scheduler of the SP.

10. The apparatus of claim 1, wherein the at least one processor is further configured to:
reserve at least one execution slot for the at least one instruction, wherein to execute the at least one instruction, the at least one processor is configured to execute the at least one instruction in the at least one execution slot.

11. The apparatus of claim 10, wherein to reserve the at least one execution slot for the at least one instruction, the at least one processor is configured to:
reserve the at least one execution slot for the at least one instruction; and
enter, in an instruction queue, one or more remaining instructions in the set of instructions.

12. The apparatus of claim 1, wherein to identify the at least one instruction based on the priority order for each of the set of instructions, the at least one processor is configured to:
select the at least one instruction based on the priority order for each of the set of instructions.

13. The apparatus of claim 12, wherein to select the at least one instruction based on the priority order, the at least one processor is configured to:
select the at least one instruction that includes a highest priority in the priority order.

14. The apparatus of claim 13, wherein one or more other instructions in the set of instructions include a lower priority in the priority order compared to the at least one instruction.

15. The apparatus of claim 1, wherein to determine the priority order for each of the set of instructions, the at least one processor is configured to:
arrange each of the set of instructions in the priority order.

16. The apparatus of claim 15, wherein to arrange each of the set of instructions in the priority order, the at least one processor is configured to:
arrange each of the set of instructions in the priority order based on a wave priority for each of the set of instructions.

17. The apparatus of claim 1, wherein the priority order for each of the set of instructions is based on a user-defined order for each of the set of instructions or a compiler-defined order for each of the set of instructions, wherein the set of instructions is a set of shader instructions associated with shader code for the graphics processing, and wherein the set of instructions is associated with a wave at a graphics processing unit (GPU).

18. The apparatus of claim 1, wherein the at least one processor is further configured to:
output an indication of the execution of the at least one instruction based on the identification of the at least one instruction.

19. A method of graphics processing, comprising:
obtaining a set of instructions associated with the graphics processing;
determining a priority order for each of the set of instructions associated with the graphics processing based on a wave priority for each of the set of instructions;
identifying at least one instruction in the set of instructions based on the priority order for each of the set of instructions; and
executing the at least one instruction based on identification of the at least one instruction.

20. A non-transitory computer-readable medium storing computer executable code for graphics processing, the code when executed by at least one processor causes the at least one processor to:
obtain a set of instructions associated with the graphics processing;
determine a priority order for each of the set of instructions associated with the graphics processing based on a wave priority for each of the set of instructions;
identify at least one instruction in the set of instructions based on the priority order for each of the set of instructions; and
execute the at least one instruction based on identification of the at least one instruction.
